(19) United States
(12) Patent Application Publication
(10) Pub. No.: US 2020/0108479 A1
(43) Pub. Date: Apr. 9, 2020

(54) Automatic Precision Worktop for Drilling without Deviation for Cylindrical Workpiece

(71) Applicant: Hing Cheung WAN, Hong Kong (HK)

(72) Inventor: Hing Cheung WAN, Hong Kong (HK)

(21) Appl. No.: 16/220,097

(22) Filed: Dec. 14, 2018

(30) Foreign Application Priority Data
Oct. 9, 2018 (CN) 201811174826.4

(51) Int. Cl. B23Q 3/06; B23B 41/12; B23Q 7/06; B23Q 7/08

(52) U.S. Cl. CPC B23Q 3/062; B23B 41/12; B23Q 2703/10; B23Q 7/08; B23Q 7/06

(57) ABSTRACT

The invention relates to an automatic precision worktop for drilling without deviation for cylindrical workpiece which includes a loading device, a drilling device and an uploading device. The loading device includes a first sliding rail disposed horizontally on the side of the drilling device, a loading plate disposed on the first sliding rail and slidingly engaged with the first sliding rail, and two first linkages driving the loading plate to slide on the first sliding rail. Each linkage includes a link mechanism, and a driving motor that drives movement of the link mechanism. Two sides of the loading plate are respectively provided with a third sliding rail slidably engaged with two link mechanisms. The drilling device includes a clamping device, a drilling mechanism located on the side of the clamping device and a positioning mechanism slidingly engaged with the clamping device. The uploading mechanism includes a second sliding rail parallel to the first sliding rail, an uploading plate located on the second sliding rail and engaging the second sliding rail, and two second linkages that drive the uploading plate to slide on the second sliding rail. The present invention avoids large deviation of the drill bit, which reduces the defective rate of the workpiece, and avoid unnecessary waste of cost.

### FIELD OF THE INVENTION

The invention relates to the field of precision workpiece processing equipment, in particular to an automatic precision worktop for drilling without deviation for cylindrical workpiece.

### BACKGROUND

A drill is a machine and equipment that uses a tool that is harder and sharper than the target to leave a cylindrical hole in the target by means of rotary cutting or rotary extrusion. In order to achieve the desired results, the precision component is drilled. The drilling machine has a semi-automatic drilling machine and a fully automatic drilling machine. With the increase of human resources costs, most enterprises consider the automatic drilling machine as the development direction.

Nowadays, the drilling machine directly drills the workpiece, but in some special cases, for example, the direct drilling on the cylindrical side of the cylindrical workpiece will slide off, causing a large error and increasing the defective rate of the workpiece and thus causing unnecessary cost waste.

### SUMMARY OF THE INVENTION

The technical problem to be solved is to overcome the above-mentioned deficiency by providing an automatic precision worktop for drilling without deviation for cylindrical workpiece.

To solve the above problem, the present invention provides the following technical solution.

An automatic precision worktop for drilling without deviation for cylindrical workpiece includes a loading device, a drilling device and an uploading device. The loading device and the uploading device are respectively disposed on two sides of the drilling device. The loading device includes a first sliding rail disposed horizontally on the side of the drilling device, a loading plate disposed on the first sliding rail and slidingly engaged with the first sliding rail, and two first linkages driving the loading plate to slide on the first sliding rail. Each linkage includes a link mechanism, and a driving motor that drives movement of the link mechanism. Two sides of the loading plate are respectively provided with a third sliding rail slidably engaged with two link mechanisms. The drilling device includes a clamping device, a drilling mechanism located on the side of the clamping device and a positioning mechanism slidingly engaged with the clamping device. The uploading mechanism includes a second sliding rail parallel to the first sliding rail, an uploading plate located on the second sliding rail and engaging the second sliding rail, and two second linkages that drive the uploading plate to slide on the second sliding rail.

Further, each of the linkages includes a first connecting rod, a second connecting rod, a first slider and a toggle block. One end of the first connecting rod is fixedly connected with the output end of the driving motor, and the other end of the first connecting rod is hinged with one end of the second connecting rod. The first connecting rod is perpendicular to the output shaft of the driving motor, and the other end of the second connecting rod is hinged with an end of the top of the first slider. One end of the toggle block is hinged with one end of the top of the first slider away from the second connecting rod. The other end of the toggle block faces the loading plate. The side of the hinged end of the toggle block is provided with a U-shaped rod with an opening facing the toggle block. The U-shaped rod is horizontally disposed. The midpoint of the U-shaped rod is provided with a rotary shaft that is disposed vertically.

Further, the loading plate is provided with a plurality of semi-cylindrical through slots with parallel and equally-spaced axis. The alignment direction of all the through slots is parallel to the longitudinal direction of the first sliding rail. Two sides of the loading plate parallel to the first sliding rail are respectively provided with toggle strips in cooperation with two first linkages. The longitudinal direction of the toggle strip is parallel to the longitudinal direction of the first sliding rail. Each of the toggle strips is provided with a plurality of equally spaced grooves. All the grooves are arranged in a direction parallel to the longitudinal direction of the first sliding rail.

Further, the clamping device includes a fixing plate, a moving plate parallel to the fixing plate, and a first driving mechanism that drives the moving plate to move along the direction of the fixing plate. The direction of the fixing plate and the moving plate is parallel to the longitudinal direction of the first sliding rail. The axial direction of the through slots is parallel to the direction of the fixing plate. The side of the loading plate away from the clamping device is provided with a push cylinder for pushing the workpiece between the fixing plate and the moving plate.

Further, the drilling mechanism is located on a side of the fixing plate away from the moving plate. The drilling mechanism includes a vertical drill press and a second driving mechanism for driving the vertical drill press to move in the axial direction of the through slots. The vertical drill press includes a drill bit that is straight down.

Further, the positioning mechanism includes a second slider that is slidably engaged with the top end of the fixing plate, a long ring that is slidably engaged with the second slider, and a rotating motor that drives the rotation of the long ring. The second slider is provided with a connecting end that is slidably engaged with the long ring. The long ring is provided with a long through hole slidably engaged with the connecting end. One side of the second slider adjacent to the moving plate is provided with a limiting sleeve for limiting the drill bit. The limiting sleeve is cylindrical and its axial direction is vertical.

Further, one side of the second slider adjacent to the moving plate is fixedly connected to the limiting sleeve through a fixing ring. The inner side of the fixing ring adjacent to the limiting sleeve is a rubber ring. The center of the limiting sleeve is provided with a limiting hole for the drill bit to pass through, and the axis of the limiting hole is vertically set.

Further, a pressure sensor is disposed on a lower portion of the fixing plate away from the moving plate. The pressure sensor is disposed adjacent to the first sliding rail. The fixing plate is provided with a blocking cylinder at the lower portion where the pressure sensor is located. The blocking cylinder is provided away from the first sliding rail. The direction of expansion and contraction of the blocking cylinder is parallel to the longitudinal direction of the first sliding rail. The output end of the blocking cylinder is provided with a blocking plate passing through the fixing plate. The direction of the blocking plate is perpendicular to the longitudinal direction of the first sliding rail.

Further, the moving plate and the fixing plate form a receiving groove for arranging the workpiece, and the middle portion of the bottom of the receiving groove is provided with a proximity sensor.

Further, the structure of the uploading plate is the same as the structure of the loading plate. The structure of the first linkage is the same as the structure of the second linkage. The axial direction of through slots of the uploading plate is parallel to the axial direction of through slots of the loading plate. The push cylinder is used to push the drilled workpiece to the uploading plate.

The technical effect of the invention is to provide an automatic precision worktop for drilling without deviation for cylindrical workpiece. The driving motor drives rotation of the first connecting rod, which drives rotation of the second connecting rod. The second connecting rod drives the first slider to slide on the third sliding rail so that the toggle block is driven to move. One end of the U-shaped rod rotates to one side of the toggle block away from the push cylinder. The toggle block moves and engages with the toggle strip so that the loading plate intermittently moves towards the push cylinder along the first sliding rail with the same distance every time. When the axis of the through slots coincides with the output direction of the push cylinder, the push cylinder pushes the workpiece into the receiving groove. The blocking cylinder limits the workpiece through the blocking plate. The first driving mechanism drives the moving plate to move towards the fixing plate to clamp the workpiece. The rotating motor drives the long ring to rotate to drive the second slider. The second driving mechanism drives the vertical drill press to move, when the axis of the drill bit and the limiting sleeve coincide, the drill press drives the drill bit to pass through the limiting hole so that the cylindrical side of the workpiece is drilled. After the workpiece is processed, the push cylinder pushes the workpiece onto the uploading plate. The second linkage drives the uploading plate to move along the second sliding rail, to avoid large deviation of the drill bit, which reduces the defective rate of the workpiece, and avoid unnecessary waste of cost.

### BRIEF DESCRIPTION OF THE DRAWINGS

The invention is illustrated by the following figures and embodiments.

FIG. 1 shows a schematic diagram of 3D structure of an automatic precision worktop for drilling without deviation for cylindrical workpiece in accordance with an example embodiment.

FIG. 2 shows a schematic diagram of 3D structure of an automatic precision worktop for drilling without deviation for cylindrical workpiece in accordance with an example embodiment.

FIG. 3 shows a schematic diagram of loading device of an automatic precision worktop for drilling without deviation for cylindrical workpiece in accordance with an example embodiment.

FIG. 4 shows an enlarged figure of A in FIG. 3.

FIG. 5 shows a schematic diagram of 3D structure of drilling device of an automatic precision worktop for drilling without deviation for cylindrical workpiece in accordance with an example embodiment.

FIG. 6 shows an enlarged figure of B in FIG. 5.

FIG. 7 shows an enlarged figure of C in FIG. 5.

FIG. 8 shows a schematic diagram of 3D structure of drilling device of an automatic precision worktop for drilling without deviation for cylindrical workpiece in accordance with an example embodiment.

FIG. 9 shows an enlarged figure of D in FIG. 8.

FIG. 10 shows a schematic diagram of 3D structure of drilling device of an automatic precision worktop for drilling without deviation for cylindrical workpiece in accordance with an example embodiment.

The reference numbers of the figures are as follows:

1: loading device; 1a: first sliding rail; 1b: loading plate; 1b1: toggle strip; 1b2: through slot; 1b3: groove; 1c: first linkage; 1c2: driving motor; 1c3: first connecting rod; 1c4: second connecting rod; 1c5: first slider; 1c6: toggle block; 1c7: U-shaped rod; 1c8: third sliding rail; 1c9: rotary shaft; 2: drilling device; 2a: clamping device; 2a1: fixing plate; 2a2: moving plate; 2a3: first driving mechanism; 2b: drilling mechanism; 2b1: vertical drill press; 2b2: second driving mechanism; 2c: positioning mechanism; 2c1: second slider; 2c2: long ring; 2c3: rotating motor; 2c4: connecting end; 2c5: fixing ring; 2c6: limiting sleeve; 2c7: limiting hole; 3: uploading device; 3a: second sliding rail; 3b:uploading plate; 3c: second linkage; 4: blocking cylinder; 4a: blocking plate; 5: receiving groove; 6: proximity sensor; 7: pressure sensor; 8: push cylinder.

### DETAILED DESCRIPTION

The invention is illustrated in accordance with figures. The figures as simplified diagrams demonstrate the basic structures of the apparatus of embodiments of the invention. Thus; the invention is not limited to the figures.

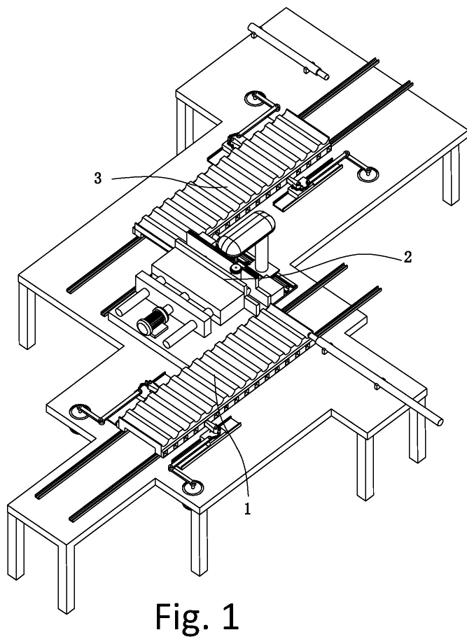

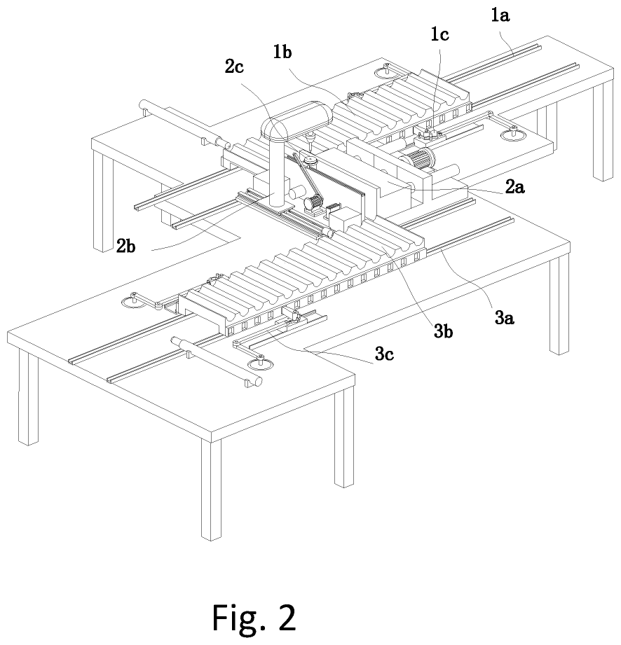

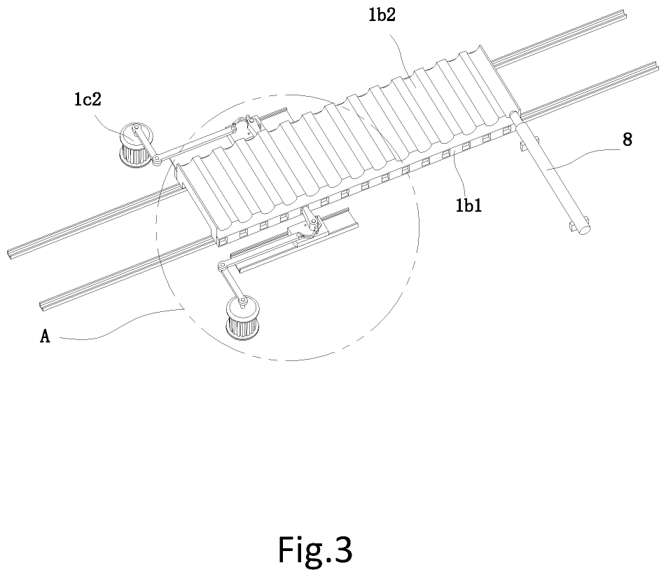

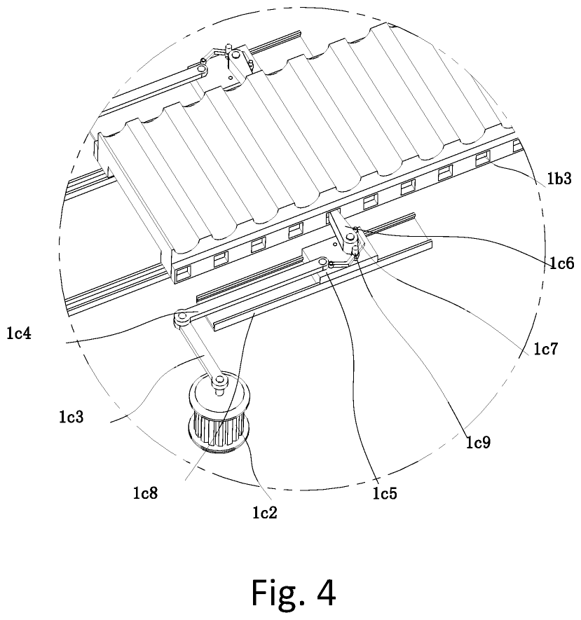

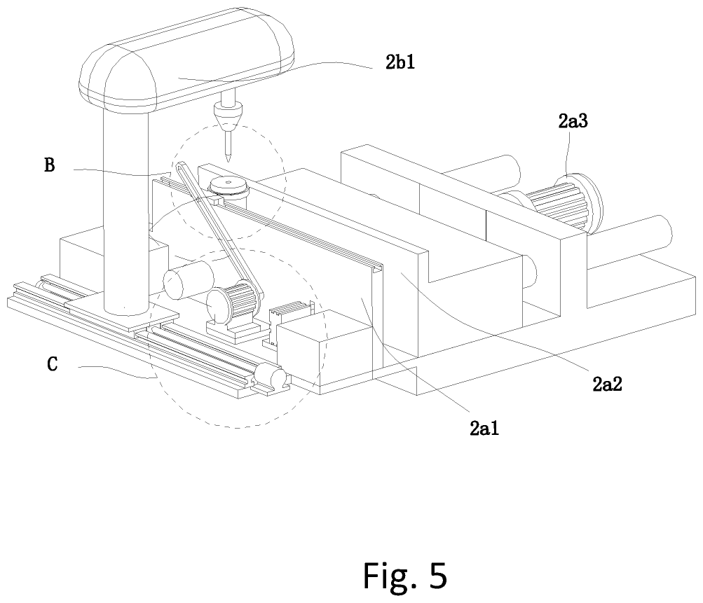

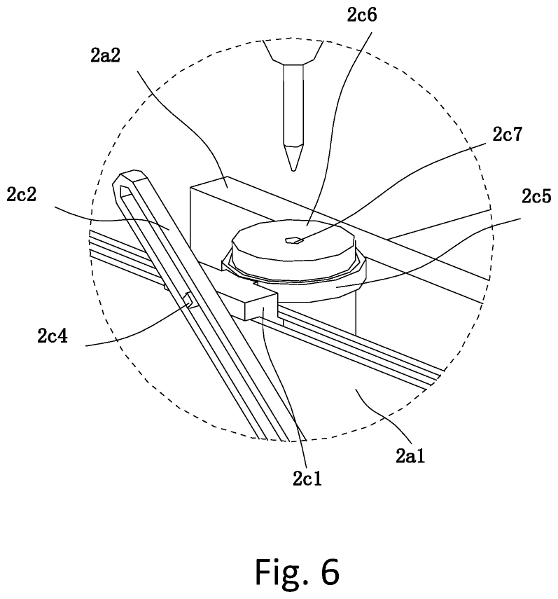

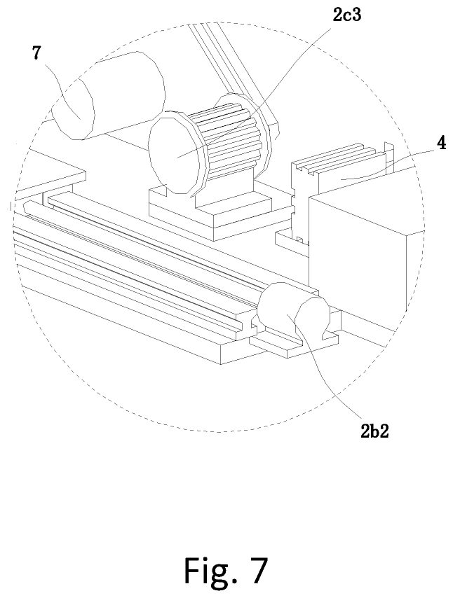

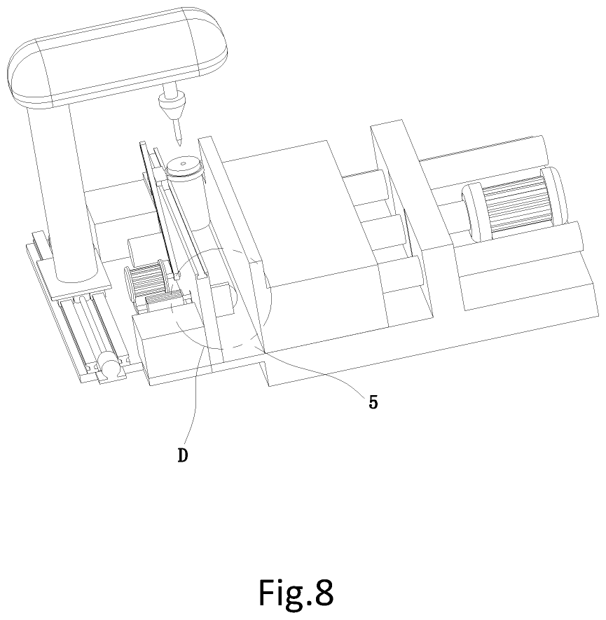

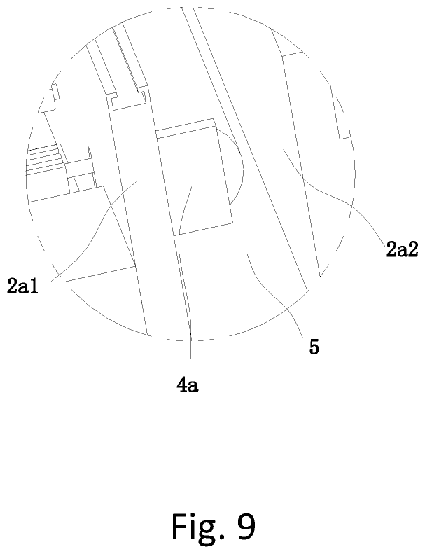

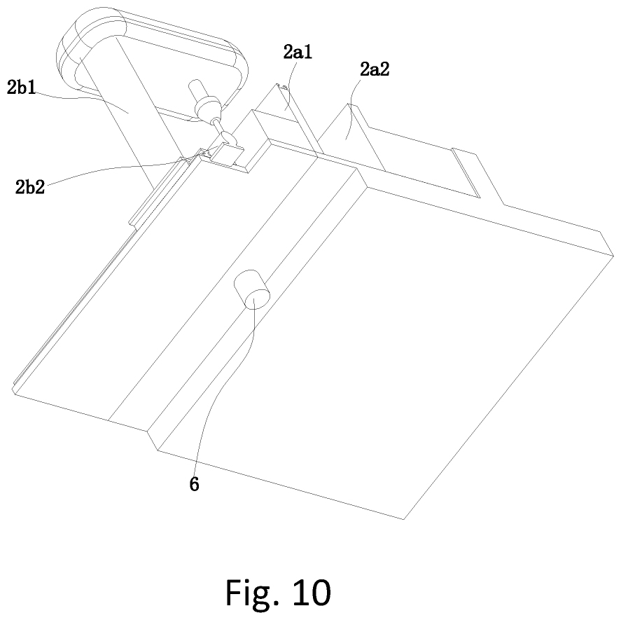

Referring to FIGS. 1-10, an automatic precision worktop for drilling without deviation for cylindrical workpiece includes a loading device 1, a drilling device 2 and an uploading device 3. The loading device 1 and the uploading device 3 are respectively disposed on two sides of the drilling device 2. The loading device 1 includes a first sliding rail 1a disposed horizontally on the side of the drilling device 2, a loading plate 1 disposed on the first sliding rail 1a and slidingly engaged with the first sliding rail 1a, and two first linkages 1c driving the loading plate 1b to slide on the first sliding rail 1a. Each linkage 1c includes a link mechanism, and a driving motor 1c2 that drives movement of the link mechanism. Two sides of the loading plate 1b are respectively provided with a third sliding rail 1c8 slidably engaged with two link mechanisms. The drilling device 2 includes a clamping device 2a, a drilling mechanism 2b located on the side of the clamping device 2a and a positioning mechanism 2c slidingly engaged with the clamping device 2a. The uploading mechanism includes a second sliding rail 3a parallel to the first sliding rail 1a, an uploading plate located on the second sliding rail 3a and engaging the second sliding rail 3a, and two second linkages 3c that drive the uploading plate 3b to slide on the second sliding rail 3a.

The working principle is that the driving motor 1c2 drives rotation of the first connecting rod 1c3, which drives rotation of the second connecting rod 1c4. The second connecting rod 1c4 drives the first slider 1c5 to slide on the third sliding rail 1c8 so that the toggle block 1c6 is driven to move. One end of the U-shaped rod 1c7 rotates to one side of the toggle block 1c6 away from the push cylinder 8. The toggle block 1c6 moves and engages with the toggle strip 1b1 so that the loading plate 1b intermittently moves towards the push cylinder 8 along the first sliding rail 1a with the same distance every time. When the axis of the through slots 1b2 coincides with the output direction of the push cylinder 8, the push cylinder 8 pushes the workpiece into the receiving groove 5. The blocking cylinder 4 limits the workpiece through the blocking plate 4a. The first driving mechanism 2a3 drives the moving plate 2a2 to move towards the fixing plate 2a2 to clamp the workpiece. The rotating motor 2c3 drives the long ring 2c2 to rotate to drive the second slider 2c1. The second driving mechanism 2b2 drives the vertical drill press 2b1 to move, when the axis of the drill bit and the limiting sleeve 2c6 coincide, the drill press drives the drill bit to pass through the limiting hole 2c7 so that the cylindrical side of the workpiece is drilled. After the workpiece is processed, the push cylinder 8 pushes the workpiece onto the uploading plate 3b. The second linkage 3c drives the uploading plate 3b to move along the second sliding rail 3a.

Each of the linkages includes a first connecting rod 1c3, a second connecting rod 1c4, a first slider 1c5 and a toggle block 1c6. One end of the first connecting rod 1c3 is fixedly connected with the output end of the driving motor 1c2, and the other end of the first connecting rod 1c3 is hinged with one end of the second connecting rod 1c4. The first connecting rod 1c3 is perpendicular to the output shaft of the driving motor 1c2, and the other end of the second connecting rod 1c4 is hinged with an end of the top of the first slider 1c5. One end of the toggle block 1c5 is hinged with one end of the top of the first slider 1c5 away from the second connecting rod 1c4. The other end of the toggle block 1c6 faces the loading plate. The side of the hinged end of the toggle block 1c6 is provided with a U-shaped rod 1c7 with an opening facing the toggle block 1c6. The U-shaped rod 1c7 is horizontally disposed.

The midpoint of the U-shaped rod 1c7 is provided with a rotary shaft 1c9 that is disposed vertically. When one end of the U-shaped rod 1c7 rotates to one side of the toggle block 1c6 away from the push cylinder 8, the toggle block 1c6 moves and engages with the toggle strip 1b1 so that the loading plate intermittently moves towards the push cylinder 8 along the first sliding rail 1a with the same distance every time. When one end of the U-shaped rod 1c7 rotates to one side of the toggle block 1c6 adjacent to the push cylinder 8, the toggle block 1c6 moves and engages with the toggle strip 1b1 so that the loading plate intermittently moves away from the push cylinder 8 along the first sliding rail la with the same distance every time.

The loading plate 1b is provided with a plurality of semi-cylindrical through slots 1b2 with parallel and equally-spaced axis. The alignment direction of all the through slots 1b2 is parallel to the longitudinal direction of the first sliding rail 1a. Two sides of the loading plate 1b parallel to the first sliding rail la are respectively provided with toggle strips 1b1 in cooperation with two first linkages 1c. The longitudinal direction of the toggle strip 1b1 is parallel to the longitudinal direction of the first sliding rail 1a. Each of the toggle strips 1b1 is provided with a plurality of equally spaced grooves 1b3. All the grooves 1b3 are arranged in a direction parallel to the longitudinal direction of the first sliding rail 1a. A plurality of workpiece are placed on the loading plate 1b. Every time when the loading plate 1b moves to a certain distance, the axis of the through slots 1b2 all face the receiving groove 5, and then the push cylinder 8 pushes the workpiece in the groove slots 1b2 to the receiving groove 5.

The clamping device 2a includes a fixing plate 2a1, a moving plate 2a2 parallel to the fixing plate 2a1, and a first driving mechanism 2a3 that drives the moving plate 2a2 to move along the direction of the fixing plate 2a1. The direction of the fixing plate 2a1 and the moving plate 2a2 is parallel to the longitudinal direction of the first sliding rail 1a. The axial direction of the through slots 1b2 is parallel to the direction of the fixing plate 2a1. The side of the loading plate 1b away from the clamping device 2a is provided with a push cylinder 8 for pushing the workpiece between the fixing plate 2a1 and the moving plate 2a2 and the moving plate 2a2 cooperates with the fixing plate 2a1 to clamp the workpiece.

The drilling mechanism 2b is located on a side of the fixing plate 2a1 away from the moving plate 2a2. The drilling mechanism 2a includes a vertical drill press 2b1 and a second driving mechanism 2b2 for driving the vertical drill press 2b1 to move in the axial direction of the through slots 1b2. The vertical drill press 2b1 includes a drill bit that is straight down. The second driving mechanism 2b2 drives the cooperation of vertical drill press 2b1 and the positioning mechanism 2c to drill the workpiece.

The positioning mechanism 2c includes a second slider 2c1 that is slidably engaged with the top end of the fixing plate 2a1, a long ring 2c2 that is slidably engaged with the second slider 2c1, and a rotating motor 2c3 that drives the rotation of the long ring 2c2. The second slider 2c1 is provided with a connecting end 2c4 that is slidably engaged with the long ring 2c2. The long ring 2c2 is provided with a long through hole slidably engaged with the connecting end 2c4. One side of the second slider 2c1 adjacent to the moving plate 2a2 is provided with a limiting sleeve 2c6 for limiting the drill bit. The limiting sleeve 2c6 is cylindrical and its axial direction is vertical. The limiting hole 2c7 of the limiting sleeve 2c6 prevents the drill bit from drilling the cylindrical side with deviation.

One side of the second slider 2c1 adjacent to the moving plate 2a2 is fixedly connected to the limiting sleeve 2c6 through a fixing ring 2c5. The inner side of the fixing ring 2c5 adjacent to the limiting sleeve 2c6 is a rubber ring. The center of the limiting sleeve 2c6 is provided with a limiting hole 2c7 for the drill bit to pass through, and the axis of the limiting hole 2c7 is vertically set. The rotating motor 2c3 drives the long ring 2c2 to rotate, and the long ring 2c2 drives the second slider 2c1 to move on the top of the fixing plate 2a1 to move the limiting sleeve 2c6. The circular cross-sectional area of the limiting sleeve 2c6 and the circular cross-sectional area of the workpiece equal.

A pressure sensor 7 is disposed on a lower portion of the fixing plate 2a1 away from the moving plate 2a2. The pressure sensor 7 is disposed adjacent to the first sliding rail 1a. The fixing plate 2a1 is provided with a blocking cylinder 4 at the lower portion where the pressure sensor 7 is located. The blocking cylinder 4 is provided away from the first sliding rail 1a. The direction of expansion and contraction of the blocking cylinder 4 is parallel to the longitudinal direction of the first sliding rail 1a. The output end of the blocking cylinder 4 is provided with a blocking plate 4a passing through the fixing plate 2a1. The direction of the blocking plate 4a is perpendicular to the longitudinal direction of the first sliding rail 1a. The present invention further includes a controller, the drive motor 1c2, the first driving mechanism 2a3, the second driving mechanism 2b2, the rotating motor 2c3, the push cylinder 8, the pressure sensor 7, the blocking cylinder 4, and the proximity sensor 6 are electrically connected to the controller.

The moving plate 2a2 and the fixing plate 2a1 form a receiving groove 5 for arranging the workpiece, and the middle portion of the bottom of the receiving groove 5 is provided with a proximity sensor 6. When the proximity sensor 6 detects the workpiece, an electrical signal is sent to the controller, and the controller controls the blocking cylinder 4 to extend out of the blocking plate 4a so that the workpiece does not continue to move within the receiving groove 5.

The structure of the uploading plate 3b is the same as the structure of the loading plate 1b. The structure of the first linkage 1 c is the same as the structure of the second linkage 3c. The axial direction of through slots 1b2 of the uploading plate 3b is parallel to the axial direction of through slots 1b2 of the loading plate 1b. The push cylinder 8 is used to push the drilled workpiece to the uploading plate 3b so that the finished workpiece automatically is uploaded.

The exemplary embodiments of the present invention are thus fully described. Although the description referred to particular embodiments; it will be clear to one skilled in the art that the present invention may be practiced with variations of these specific details. Hence this invention should not be construed as limited to the embodiments set forth herein.

What is claimed is:

1. An automatic precision worktop for drilling without deviation for cylindrical workpiece, comprising: a loading device 1, a drilling device 2 and an uploading device 3, wherein the loading device 1 and the uploading device 3 are respectively disposed on two sides of the drilling device 2; the loading device 1 includes a first sliding rail la disposed horizontally on the side of the drilling device 2, a loading plate 1 disposed on the first sliding rail 1a and slidingly engaged with the first sliding rail 1a, and two first linkages 1c driving the loading plate 1b to slide on the first sliding rail 1 a; each linkage 1c includes a link mechanism, and a driving motor 1c2 that drives movement of the link mechanism; two sides of the loading plate 1b are respectively provided with a third sliding rail 1c8 slidably engaged with two link mechanisms; the drilling device 2 includes a clamping device 2a, a drilling mechanism 2b located on the side of the clamping device 2a and a positioning mechanism 2c slidingly engaged with the clamping device 2a; the uploading mechanism includes a second sliding rail 3a parallel to the first sliding rail 1a, an uploading plate located on the second sliding rail 3a and engaging the second sliding rail 3a, and two second linkages 3c that drive the uploading plate 3b to slide on the second sliding rail 3a,
wherein each of the linkages includes a first connecting rod 1c3, a second connecting rod 1c4, a first slider 1c5 and a toggle block 1c6; one end of the first connecting rod 1c3 is fixedly connected with the output end of the driving motor 1c2, and the other end of the first connecting rod 1c3 is hinged with one end of the second connecting rod 1c4; the first connecting rod 1c3 is perpendicular to the output shaft of the driving motor 1c2, and the other end of the second connecting rod 1c4 is hinged with an end of the top of the first slider 1c5; one end of the toggle block 1c5 is hinged with one end of the top of the first slider 1c5 away from the second connecting rod 1c4; the other end of the toggle block 1c6 faces the loading plate; the side of the hinged end of the toggle block 1c6 is provided with a U-shaped rod 1c7 with an opening facing the toggle block 1c6; the U-shaped rod 1c7 is horizontally disposed; the midpoint of the U-shaped rod 1c7 is provided with a rotary shaft 1c9 that is disposed vertically.

2. The automatic precision worktop for drilling without deviation for cylindrical workpiece of claim 1, wherein the loading plate 1b is provided with a plurality of semi-cylindrical through slots 1b2 with parallel and equally-spaced axis; the alignment direction of all the through slots 1b2 is parallel to the longitudinal direction of the first sliding rail 1a; two sides of the loading plate 1b parallel to the first sliding rail 1a are respectively provided with toggle strips 1b1 in cooperation with two first linkages 1c; the longitudinal direction of the toggle strip 1b1 is parallel to the longitudinal direction of the first sliding rail 1a; each of the toggle strips 1b1 is provided with a plurality of equally spaced grooves 1b3; all the grooves 1b3 are arranged in a direction parallel to the longitudinal direction of the first sliding rail 1a.

3. The automatic precision worktop for drilling without deviation for cylindrical workpiece of claim 1, wherein the clamping device 2a includes a fixing plate 2a1, a moving plate 2a2 parallel to the fixing plate 2a1, and a first driving mechanism 2a3 that drives the moving plate 2a2 to move along the direction of the fixing plate 2a1; the direction of the fixing plate 2a1 and the moving plate 2a2 is parallel to the longitudinal direction of the first sliding rail 1 a; the axial direction of the through slots 1b2 is parallel to the direction of the fixing plate 2a1; the side of the loading plate 1b away from the clamping device 2a is provided with a push cylinder 8 for pushing the workpiece between the fixing plate 2a1 and the moving plate 2a2.

4. The automatic precision worktop for drilling without deviation for cylindrical workpiece of claim 1, wherein the drilling mechanism 2b is located on a side of the fixing plate 2a1 away from the moving plate 2a2; the drilling mechanism 2a includes a vertical drill press 2b1 and a second driving mechanism 2b2 for driving the vertical drill press 2b1 to move in the axial direction of the through slots 1b2; the vertical drill press 2b1 includes a drill bit that is straight down.

5. The automatic precision worktop for drilling without deviation for cylindrical workpiece of claim 1, wherein the positioning mechanism 2c includes a second slider 2c1 that is slidably engaged with the top end of the fixing plate 2a1, a long ring 2c2 that is slidably engaged with the second slider 2c1, and a rotating motor 2c3 that drives the rotation of the long ring 2c2; the second slider 2c1 is provided with a connecting end 2c4 that is slidably engaged with the long ring 2c2; the long ring 2c2 is provided with a long through hole slidably engaged with the connecting end 2c4; one side of the second slider 2c1 adjacent to the moving plate 2a2 is provided with a limiting sleeve 2c6 for limiting the drill bit; the limiting sleeve 2c6 is cylindrical and its axial direction is vertical.

6. The automatic precision worktop for drilling without deviation for cylindrical workpiece of claim 1, wherein one side of the second slider 2c1 adjacent to the moving plate 2a2 is fixedly connected to the limiting sleeve 2c6 through a fixing ring 2c5; the inner side of the fixing ring 2c5 adjacent to the limiting sleeve 2c6 is a rubber ring; the center of the limiting sleeve 2c6 is provided with a limiting hole 2c7 for the drill bit to pass through, and the axis of the limiting hole 2c7 is vertically set.

7. The automatic precision worktop for drilling without deviation for cylindrical workpiece of claim 1, wherein a pressure sensor 7 is disposed on a lower portion of the fixing plate 2a1 away from the moving plate 2a2; the pressure sensor 7 is disposed adjacent to the first sliding rail 1 a; the fixing plate 2a1 is provided with a blocking cylinder 4 at the lower portion where the pressure sensor 7 is located; the blocking cylinder 4 is provided away from the first sliding rail 1a; the direction of expansion and contraction of the blocking cylinder 4 is parallel to the longitudinal direction of the first sliding rail 1a; the output end of the blocking cylinder 4 is provided with a blocking plate 4a passing through the fixing plate 2a1; the direction of the blocking plate 4a is perpendicular to the longitudinal direction of the first sliding rail 1a.

8. The automatic precision worktop for drilling without deviation for cylindrical workpiece of claim 1, wherein the moving plate 2a2 and the fixing plate 2a1 form a receiving groove 5 for arranging the workpiece, and the middle portion of the bottom of the receiving groove 5 is provided with a proximity sensor 6.

9. The automatic precision worktop for drilling without deviation for cylindrical workpiece of claim 1, wherein the structure of the uploading plate 3b is the same as the structure of the loading plate 1b; the structure of the first linkage 1c is the same as the structure of the second linkage 3c; the axial direction of through slots 1b2 of the uploading plate 3b is parallel to the axial direction of through slots 1b2 of the loading plate 1b; the push cylinder 8 is used to push the drilled workpiece to the uploading plate 3b so that the finished workpiece automatically is uploaded.
